(19) United States
(12) Patent Application Publication
(10) Pub. No.: US 2010/0120275 A1
(43) Pub. Date: May 13, 2010

(54) SAFETY ELECTRIC SOCKET

(76) Inventors: Fu-Hsiang Huang, Taichung County (TW); Chang-Chin Yang, Taichung City (TW)

Correspondence Address: BROWDY AND NEIMARK, P.L.L.C.;624 NINTH STREET, NW, SUITE 300, WASHINGTON, DC, 20001-5303, US

(21) Appl. No.: 12/268,361

(22) Filed: Nov. 10, 2008

(51) Int. Cl. H01R 13/44

(52) U.S. Cl. 439/148

(57) ABSTRACT

An electric socket includes a main member having two apertures. A first block member and a second block member have a first block portion and a second block portion respectively. The first block member and a second block member are received in the main member. An elastic member urging the first block member and the second block member to have the first block portion of the first block member and the second block portion of the second block member under one aperture and the first block portion of the second block member and the second block portion of the first block member under the other aperture. The first block member and the second block member are moved independently that when an improper stuff is inserted into one of the aperture, only one block portion is moved away, and the other block portion will stand still to serve protection function.

### BACKGROUND OF THE INVENTION

1. Field of the Invention

The present invention relates to an electric socket and more particularly, to an electric socket capable of prevent electric shock by insertion of improper stuffs.

2. Description of the Related Art

The operation of plug and socket is very common in everyday. Typically, a conventional socket has an insulating casing having two or three apertures thereon and electrodes in the casing behind the apertures. The plug has two or three prongs to be inserted into the apertures of the socket and electrically contact the electrodes.

In home accidents, there always are children inserting wires or other improper stuffs into the socket to get electric shock. To prevent electric shock accident, socket shields are the most common device that the parents use. Such socket shield is made of an insulating material, such as plastic, having a lid and two prongs on a back of the lid. Same as the plug, user may insert the prongs of the sock shield into the apertures of the socket to prevent children touching the socket. When the socket is needed, user may hold a ring on the lid and pull the socket shield out. It always happens that people forgets to put the socket shield back when he/she pulls the plug out, or the socket shield is missing that would make the socket exposing. Besides, the socket shield is not functional for elder children because they might learn how to remove the socket shield

### SUMMARY OF THE INVENTION

The primary objective of the present invention is to provide an electric socket, which may prevent children inserting an improper stuff into the socket.

To achieve the objective of the present invention, an electric socket includes a main member having two apertures on a top thereof. A first block member and a second block member have a first block portion and a second block portion respectively. The first block member and a second block member are received in the main member. An elastic member urging the first block member and the second block member to have the first block portion of the first block member and the second block portion of the second block member under one of the apertures and the first block portion of the second block member and the second block portion of the first block member under the other one of the apertures. The first block member and the second block member are moved independently that when an improper stuff is inserted into the aperture, only one block portion is moved away, and the other block portion will stand still to serve protection function.

### BRIEF DESCRIPTION OF THE DRAWINGS

FIG. 1 is an exploded view of a preferred embodiment of the present invention;

FIG. 2 is a perspective view of the preferred embodiment of the present invention;

FIG. 3 is a sectional view along the 3-3 line of FIG. 2;

FIG. 4 is a sectional view the preferred embodiment of the present invention, showing, showing an improper stuff inserted into the left aperture of the socket of the present invention;

FIG. 5 is a sectional view the preferred embodiment of the present invention, showing, showing an improper stuff inserted into the right aperture of the socket of the present invention; and

FIG. 6 is a sectional view the preferred embodiment of the present invention, showing, showing a plug inserted into the socket of the present invention.

### DETAILED DESCRIPTION OF THE INVENTION

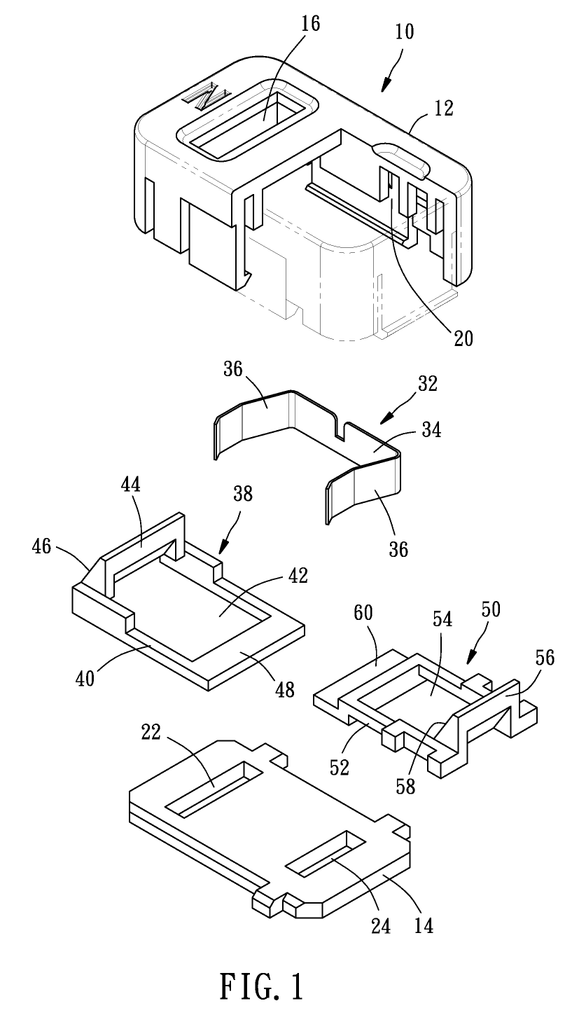

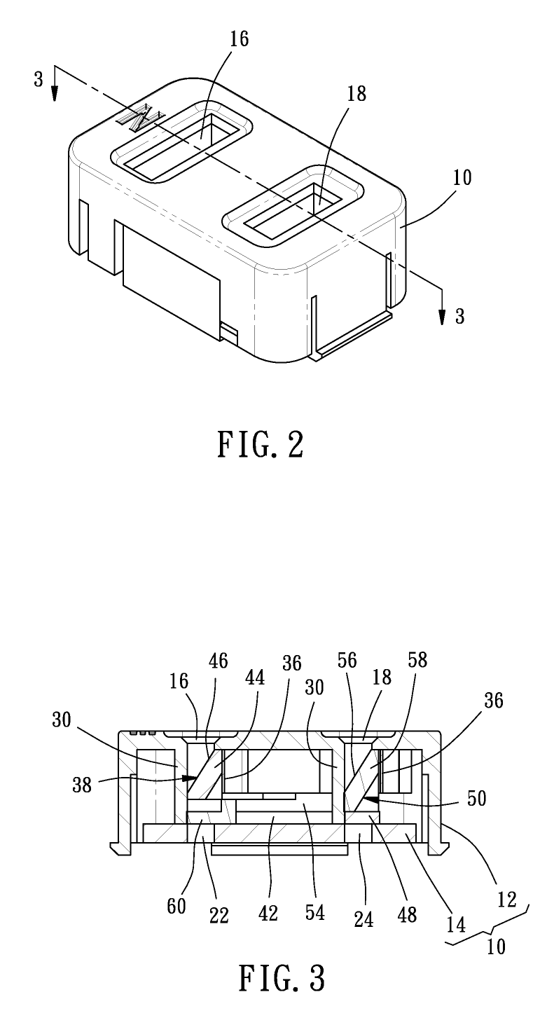

FIGS. 1˜3 show an electric socket of the preferred embodiment of the present invention, which includes a main member 10, a first block member 38, a second block member 50, and an elastic member 32.

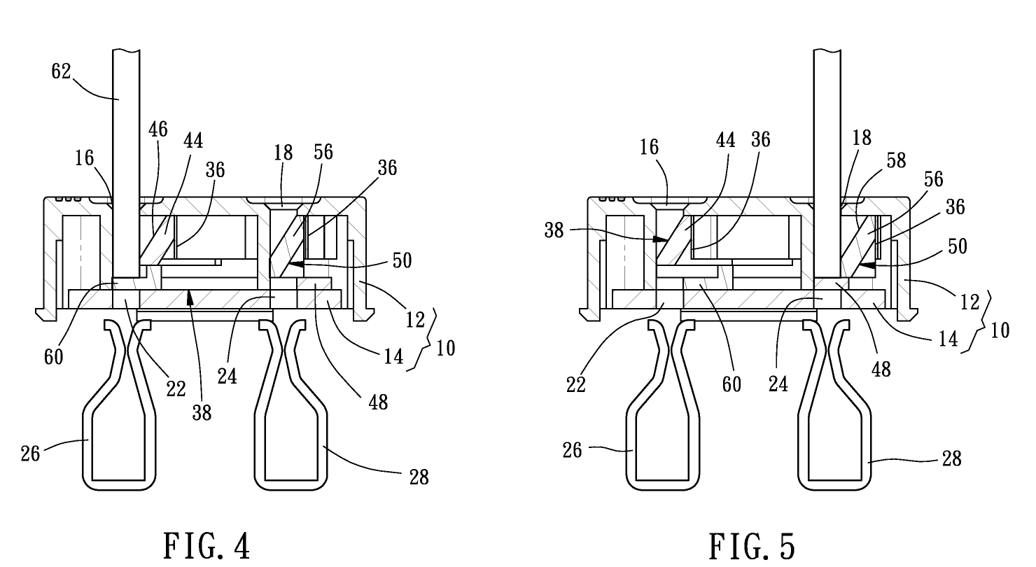

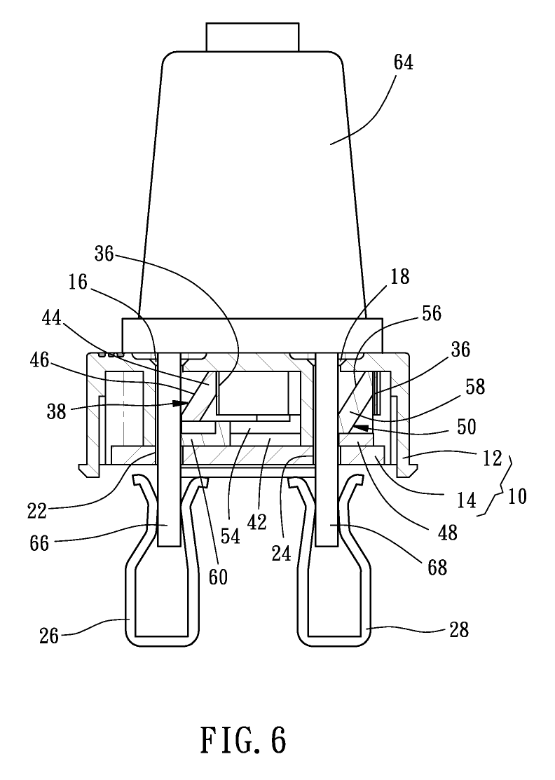

The main member 10 includes a lid 12 and a base 14. The lid 12 is an up-side-down box having two apertures 16, 18 on a top thereof. On an inner side of the lid 12 has a slot 20. The base 14 is a board to be combined with a bottom of the lid 12. The base 14 has two apertures 22, 24 in association with the apertures 16, 18 of the lid 12. Two electrodes 26, 28, as shown in FIG. 4, are provided under the apertures 22, 24. Besides, two positioning plates 30 are projected from an inner side of the top of the lid 12 beside the aperture 16, 18 respectively, as shown in FIG. 3.

The elastic member 32 is a U-shaped metal member having a connection section 34 and two flexible sections 36 on opposite ends of the connection section 34. The connection section 34 is engaged with the slot 20 on the lid 12 that the flexible sections 36 are suspended in the main member 10.

The first block member 38 has a board 40 having a bore 42, a vertical first block portion 44 on a left of the bore 42, and a second block portion 48 on a right. The first block portion 44 has a sloping driving face 46. In other words, the first block member 38 has the first block portion 44 and the second block portion 48 on opposite sides and the bore 42 at a center. In a vertical direction, the first block portion 44 is higher than the second block portion 48.

The second block member 50 has a board 52 having a bore 54 at a center, a vertical first block portion 56 on a right, and a second block portion 60 on a left. The first block portion 56 has a sloping driving face 58. The first block portion 56 is higher than the second block portion 60, and the second block portion 60 is lower than the board 52.

As shown in FIG. 3, the second block portion 60 of the second block member 50 is received in the bore 42 of the first block member 38 that the first block member 38 and the second block member 50 are combined and may move relative to each other. At this condition, the second block portion 60 of the second block member 50 and the second block portion 48 of the first block member 38 are on the same height, and the first block portions 44 and 56 are on the same height also and higher than the second block portions 48 and 60. The first block portion 44 of the first block member 38 is right above the second block portion 60 of the second block member 50, and the first block portion 56 is right above the second block portion 60 of the second block member 50. The first block member 38 and the second block member 50 are installed in the main member 10 with the flexible sections 36 urging right sides of the first block portions 44 and 56. The right positioning plate 30 is inserted into the bores 42, 54 of the first block member 38 and the second block member 50 that the flexible sections 36 urge the first block member 38 and the second block member 50 having the first block portion 56 and the second block portion 48 against the right positioning plate 30 at an initial condition. The left positioning plate 30 is on the lefts of the first block member 38 and the second block member 50, and the flexible sections 36 urge the first block portion 44 and the second block portion 60 against the left positioning plate 30 at the initial condition. The first block portion 44 of the first block member 38 and the second block portion 60 of the second block member 50 are right under the left aperture 16, and the first block portion 56 and the second block portion 60 of the second block member 50 are right under the right aperture 18. In other words, there are two block portions between each pair of the apertures 16, 18 and electrodes 26, 28.

As shown in FIG. 4, when someone inserts an improper stuff 62 into the left aperture 16 of the electric socket of the present invention, the stuff 62 will press the driving face 46 of the first block portion 44 of the first block member 38 to move the first block portion 44 away (the first block member 38 will be moved to right). The second block member 50, however, stays still that the improper stuff 62 will be blocked by the second block portion 60 of the second block member 50 to stop the improper stuff 62 in touch with the electrode 26. At this condition, the right aperture 18 still is closed by the first block portion 56 of the second block member 50.

For the same principle, as shown in FIG. 5, when an improper stuff 62 is inserted into the right aperture 18 of the electric socket of the present invention, it will move the first block portion 56 of the second block member 50 away, and the second block portion 48 of the first block member 38 stands still to block improper stuff 62.

When a normal plug 64 is inserted into the right aperture 18 of the electric socket of the present invention, branches 66, 68 of the plug 64 will press the driving faces 46, 58 of the first and second block members 38, 50 at same time to move both of the first and second block members 38, 50 to right that the first block portions 44, 56 and the second block portions 48, 60 of the first and second block members 38, 50 will be moved away from the apertures 16, 18, and the branches 66, 68 of the plug 64 may enter the main member 10, go through the apertures 22, 24, and touch the electrodes 26, 28. It is mentioned that the right branch 68 of the plug 64 will go through the bore 42 of the first block member 38 when the first block member 38 is moved away.

In above embodiment, both of the first and second block members 38, 50 are moved to the same direction (the right). It is easy to understand that it may design that the first and second block members to be moved to opposite directions. It may achieve the same function.

In conclusion, the present invention provides two block portions under each aperture of the electric socket that when one block portion is moved away, the other block portion will keep serving the protection function.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electric socket, comprising:
a main member having two apertures on a top thereof;
a first block member, which is provided in said main member for movement, having a first block portion and a second block portion;
a second block member, which is provided in said main member for movement, having a first block portion and a second block portion; and
an elastic member urging said first block member and said second block member to have said first block portion of said first block member and said second block portion of said second block member under one of said apertures and said first block portion of said second block member and said second block portion of said first block member under the other one of said apertures;
wherein said first block member is moved independently to have said first block portion and said second block portion thereof departing from said apertures respectively; and said second block member is moved independently to have said first block portion and said second block portion thereof departing from said apertures respectively.

2. The electric socket as claimed in claim 1, wherein said first block member has a bore between said first block portion and said second block portion.

3. The electric socket as claimed in claim 2, wherein said first block portion of said first block member, which is proximal to said aperture than said second block portion of said second block member, has a driving face.

4. The electric socket as claimed in claim 2, wherein said second block portion of said second block member is received in said bore of said first block member for movement along said bore.

5. The electric socket as claimed in claim 4, wherein said second block portion of said first block member and said second block portion of said second block member are on the same height.

6. The electric socket as claimed in claim 1, wherein said elastic member has a connection section fixed to said main member, and two flexible sections on opposite ends of said connection section to urge said first block portion of said first block member and said first block portion of said second block member respectively.

7. The electric socket as claimed in claim 1, wherein said first block portion of said first block member is proximal to said aperture than said second block portion of said second block member, and said first block portion of said second block member is proximal to said aperture than said second block portion of said first block member.

8. The electric socket as claimed in claim 7, wherein said first block portion of said first block member has a driving face, and said first block portion of said second block member has a driving face.

9. The electric socket as claimed in claim 1, wherein said first block member has a bore, and said second block member has a bore, and said main member has a positioning plate inserted into both of said bores of said first block member and said second block member.

10. The electric socket as claimed in claim 9, wherein said elastic member urge said first block member and said second block member to have edges of said bores thereof against said positioning plate.

11. The electric socket as claimed in claim 1, wherein said main member has a positioning plate beside first block member and said second block member, and said first block member and said second block member toward said positioning plate.
